(19) United States
(12) Patent Application Publication
(10) Pub. No.: US 2009/0010154 A1
(43) Pub. Date: Jan. 8, 2009

(54) Protection Scheme

(76) Inventors: Riccardo Martinotti, Savona (IT); Andrea Corti, Varazze (SV) (IT); Raoul Fiorone, Genova (IT)

Correspondence Address: COATS & BENNETT, PLLC, 1400 Crescent Green, Suite 300, Cary, NC, 27518, US

(21) Appl. No.: 11/965,828

(22) Filed: Dec. 28, 2007

(30) Foreign Application Priority Data
Dec. 28, 2006 (EP) PCT/EP2006/012575

(51) Int. Cl. H04L 12/24

(52) U.S. Cl. 370/228

(57) ABSTRACT

A protection scheme for a metro optical network involves programming ingress nodes and egress nodes with a primary multicast label switched path (LSP) and a back-up LSP to provide one-to-one protection. The primary and back-up LSPs are configured prior to the occurrence of a network fault to allow the network to transmit multicast communication when the fault occurs. Particularly, multicast communications are sent on the primary LSP during normal operation. However, when a network fault occurs, the nodes also send a duplicate multicast communication over the back-up LSP. Configuring the primary and back-up LSPs prior to the fault occurring avoids the need for signalling to establish a working LSP after a fault occurs.

### RELATED APPLICATIONS

This application claims priority from foreign application PCT/EP2006/012575 filed on Dec. 28, 2006. That application is incorporated herein by reference in its entirety.

### FIELD OF THE INVENTION

This invention relates to a protection scheme for multicast communication in a network, and has particular, but not exclusive, application in a network using multi-protocol label switching (MPLS) for routing packets through the network.

### BACKGROUND OF THE INVENTION

Networks based in a metropolitan area are often referred to as Metro networks. Such networks are arranged to provide communication capabilities between residential users, business users, Internet service providers, network operators and the like.

Metro networks can advantageously employ MPLS to direct communications in the form of packets through the network to an end-user. In these networks there is a demand for communications to be multicast to the end users, for example, in multimedia applications such as video streaming, Internet protocol television (IPTV) or the like. This is achieved by using multicast label switched paths (LSPs).

For data being streamed to the user for real-time processing, it is necessary for data to be streamed to the user at a required data rate. Faults in the network can be a barrier to this requirement, causing traffic interruptions or degradations. To maintain communication at the required data rate between the supplier and the end-user, even when a fault occurs in the network, protection schemes are provided in such networks.

Several schemes presently exist which offer restoration and/or protection in the event of a failure of a multicast LSP within the network.

FIG. 1 shows a metro network having one-to-one LSP protection. The network comprises nodes 2A to 2F connected together by a communication link 1 in the form of a fibre optic ring. Each egress node 2B to 2F is connected to the final users (in a residential environment in the figure) via an access node 6. Node 2A is an ingress node connected to a video server 3 and an Internet service provider (ISP) 4 through a router 5. The node 2A is arranged to determine which LSP to send packets on dependent upon the egress nodes 2B to 2F the packets need to reach, as is conventional in a LSP network

In FIG. 1 there is shown a primary LSP 7 on which packets of a video stream are sent multicast to nodes 2B, 2C and 2E. For primary LSP 7 there is also provided one back-up LSP 8. The ingress node 2A is pre-configured with these LSPs 7,8. During normal operation, the packets are sent multicast along the primary LSP 7, however when a fault is reported to the ingress node 2A that prevents communication along the primary LSP 7, the ingress node switches the communication to the back-up LSP 8.

This protection scheme has the advantage that it consumes no extra bandwidth for protection compared to other schemes, however, as now illustrated with respect to FIG. 2, as the LSPs 7 and 8 are pre-configured prior to failure, in some situations the scheme can fail to maintain the required multicast communication on the network, thus failing in practice to reach one or more egress nodes.

FIG. 2 shows a fault 10 occurring in the network that prevents communication between egress nodes 2B and 2C. This fault interrupts communication along the primary LSP 7 to nodes 2C and 2E. The ingress node 2A therefore, on receiving a fault notification 9, switches communication to the back-up LSP 8. However, this is not sufficient to maintain the required multicast communication because communications along the back-up LSP 8 fail to reach node 2B due to the fault. Therefore, the one-to-one protection scheme with pre-configured LSPs can fail to maintain the multicast communication.

A scheme that has been developed to overcome this deficiency is shown in FIG. 3. In this scheme rather than the ingress node 2A being pre-configured with a back-up LSP 8, the ingress node 2A computes the back-up LSP 8′ on-demand in response to a fault notification 9 that includes information on the location of the fault. The ingress node 2A determines a back-up LSP 8′ that avoids communication along the optic fibre that has failed. However, in order to achieve a multicast LSP 8′ on-demand, the LSP 8′ first has to be computed by the ingress node 2A and then established through signalling between the nodes 2. This has a number of disadvantages. Firstly, the extra computing and signalling that needs to be carried out consumes processing power and to some extent bandwidth reducing the speed of the network. Secondly, it cannot be easily incorporated into current metro networks because no complete solution for signalling multicast LSPs actually has been standardised to date.

### SUMMARY OF THE INVENTION

According to a first aspect of the invention there is provided a method of sending a multicast communication across a network comprising an ingress node connected to a plurality of egress nodes via a communication link such that communications can be sent to each egress node from the ingress node along more than one path, the method comprising configuring the nodes in advance of a fault occurring in the network with a primary path along the link on which to send multicast communications and a back-up path along the link on which to send the multicast communications and, if the fault occurs, sending a multicast communication on the primary path and a duplication of the multicast communication on the back-up path.

Sending a multicast communication on the primary path and a duplication of the multicast communication on the back-up path when a fault occurs ensures that the multicast communication reaches all of the required egress nodes without requiring additional computing by the ingress node that could significantly reduce the speed of the network protection or signalling to establish a back-up path.

The nodes may be configured in advance of a fault with a plurality of primary paths, each primary path for sending a multicast communication along the link to a unique set of egress nodes. The nodes may also be configured with a back-up path for each primary path. In this way, one-to-one protection is provided.

The primary path and back-up path may be multicast label switched paths (multicast LSPs).

The method may comprise stopping the sending of the duplicate multicast communication on the back-up path in response to the ingress node being notified that there is no longer the fault in the network. The response may not be immediate, but may be delayed by a pre-set amount. In this way, the method ensures that all egress nodes have reverted to receiving the multicast communication via the primary path before switching off the back-up path. The preset delay may be configured by the network operator, and, for instance, can range from some milliseconds to a few seconds or even more, depending on the specific choices of the network operator. Such delay has to be set in order to provide sufficient time for all egress nodes to revert to using the primary path while avoiding any significant effects on the data traffic.

The method may comprise switching the egress nodes to revert back to receiving the multicast communication on the primary path a predetermined period of time after receiving notification that the fault has been fixed. In this way, the egress nodes only switch back to receiving the communication on the primary path once a stable communication has been established.

According to a second aspect of the invention there is provided an ingress node for a network in which the ingress node is connected to a plurality of egress nodes via a communications link such that communications can be sent to each egress node from the ingress node along more than one path, the ingress node arranged to be configured in advance of a fault occurring in the network with a primary path along the link on which to send multicast communications and a back-up path along the link on which to send the multicast communications and to send a multicast communication on the primary path and a duplication of the multicast communication on the back-up path if the fault occurs.

According to a third aspect of the invention there is provided, a data carrier for a network comprising an ingress node connected to a plurality of egress nodes via a communications link such that communications can be sent to each egress node from the ingress node along more than one path and the nodes being configured in advance of a fault occurring in the network with a primary path along the link on which to send multicast communications and a back-up path along the link on which to send the multicast communications, the data carrier comprising instructions that when executed by a processor cause the processor to operate the ingress node of the network such that, in response to receiving a notification that the fault has occurred, the ingress node sends a multicast communication on the primary path and a duplication of the multicast communication on the back-up path.

According to a fourth aspect of the invention there is provided an egress node for a network in which the egress node is one of many egress nodes connected to an ingress node via a communications link such that communications can be sent to each egress node from the ingress node along more than one path, the egress node arranged to be configured, in advance of a fault occurring, with a primary path on which the egress node can receive multicast communications and a back-up path on which the egress node can receive the multicast communications, to receive a multicast communication along a primary path and, in response to detecting that communication to the egress node on the primary path has failed, identifying if a duplicate of the multicast communication can be received on the back-up path and, if so, switching to receive the duplicate of the multicast communication.

It will be understood that “receive” used herein means to detect or to pick up not simply to have sent to.

The egress node of the invention is advantageous as it only switches to the back-up path if communication in the primary path has failed, independent of each other egress node in the network. In this way, the ingress node can send communications to the egress node along the primary path if communications along the primary path are still possible.

The egress node may be arranged to switch to receiving the multicast communication on the primary path a predetermined period of time after receiving notification that the fault has been fixed.

According to a fifth aspect of the invention there is provided, a data carrier for a network comprising an ingress node connected to a plurality of egress nodes via a communications link such that a communication can be sent to each egress node from the ingress node along more than one path and the nodes being configured in advance of a fault occurring in the network with a primary path along the link on which to send multicast communications and a back-up path along the link on which to send the multicast communications, the data carrier comprising instructions that when executed by a processor cause the processor to operate the egress node of the network to receive a multicast communication along a primary path and, if the egress node fails to receive the multicast communication along the primary path, identifying if a duplicate of the multicast communication can be received on the back-up path and, if so, switching to receive the duplicate of the multicast communication.

According to a sixth aspect of the invention there is provided a network comprising an ingress node connected to a plurality of egress nodes via a communications link such that communications can be sent to each egress node from the ingress node along more than one path, the nodes configured in advance of a fault occurring in the network with a primary path along the link on which to send multicast communications and a back-up path along the link on which to send the multicast communications and the nodes arranged to send a multicast communication on the primary path and a duplication of the multicast communication on the back-up path, if the fault occurs.

The communication link may be a ring, in particular a fibre optic ring, connecting the nodes together, wherein communication can occur in both directions along the ring. In this way, two paths are provided to each egress node from the ingress node.

The communication link may provide one-to-one protection for each path through the network; that is that for each primary path through the network there is a separate back-up path.

Alternatively, the communication link may provide many-to-one protection, with multiple primary paths being protected via a single back-up path.

The communication link may provide protection against failure of the link between two nodes, a node and/or a failure of the link between two nodes as well as a node.

Each egress node may be arranged to receive the duplication of the multicast communication along the back-up path only if the egress node fails to receive the multicast communication along the primary path. For example, the egress nodes may operate by switching to receive multicast communications on the back-up path in response to failure to receive the multicast communication on the primary path.

The ingress node may be arranged to send the multicast communication on the primary path and a duplication of the multicast communication on the back-up path on receiving a communication notifying the ingress node of the fault in the network.

The node may be a switch, a router or other network device capable of being deployed in a packet switched network, conveniently based upon a connection oriented technology.

The network may use multi-protocol label switching (MPLS) for forwarding packets through the network, with the primary path and back-up path being specific label switched paths (LSPs) in the network.

The network may use connection oriented Ethernet for forwarding packets through the network, with the primary path and back-up path being specific connections in the network.

The multicast communication may be a communication of data for multimedia applications or real-time processing at a destination device, for example, the multicast communication may be video streaming or Internet protocol television (IPTV) or the like.

### BRIEF DESCRIPTION OF THE DRAWINGS

An embodiment of the invention will now be described, by example only, with reference to the accompanying drawings, in which:—

FIG. 1 is a schematic view of a prior art metropolitan network that uses multi-protocol label switching (MPLS) with pre-established LSP one-to-one protection;

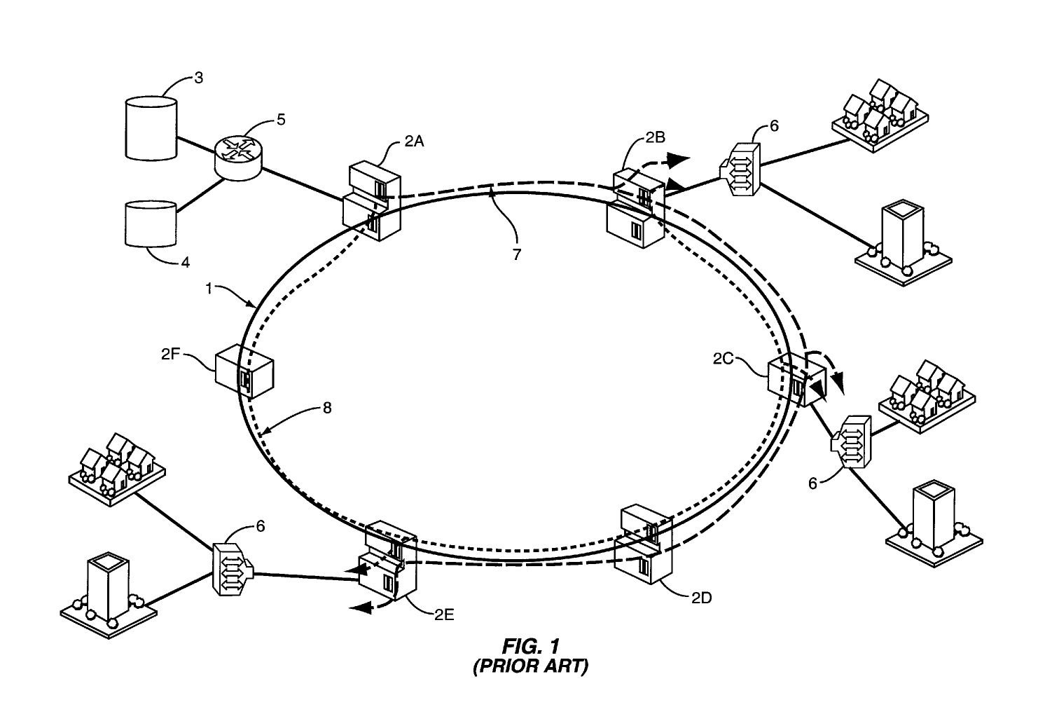

FIG. 2 is a schematic view of the prior art network of FIG. 1 in which a fault has occurred;

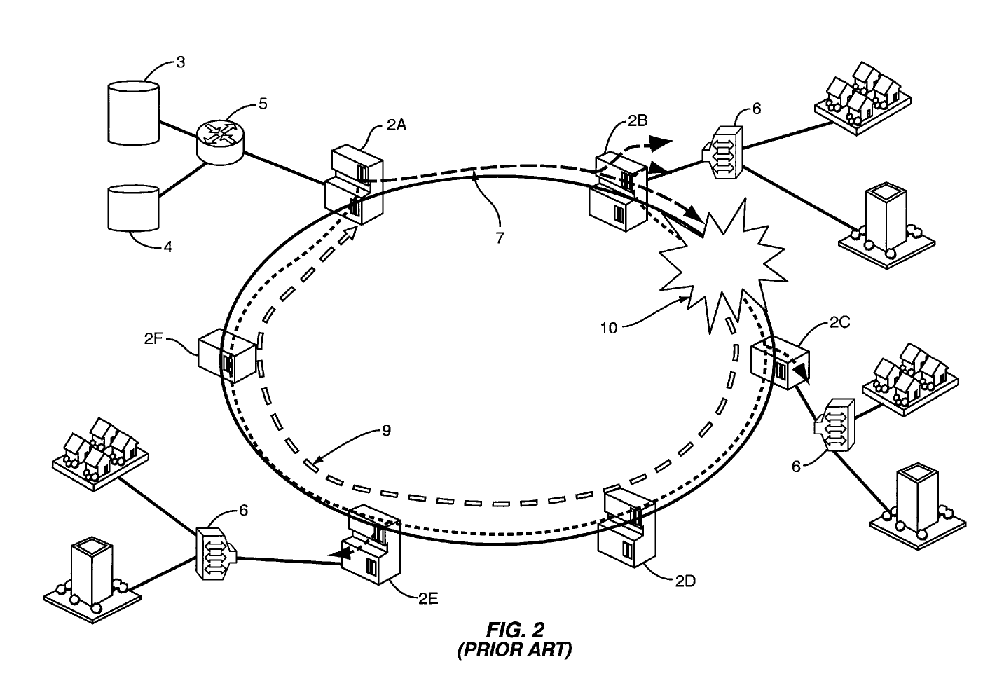

FIG. 3 is a schematic view of a prior art metropolitan network that uses multi-protocol label switching (MPLS) with LSP one-to-one protection provided on-demand; and

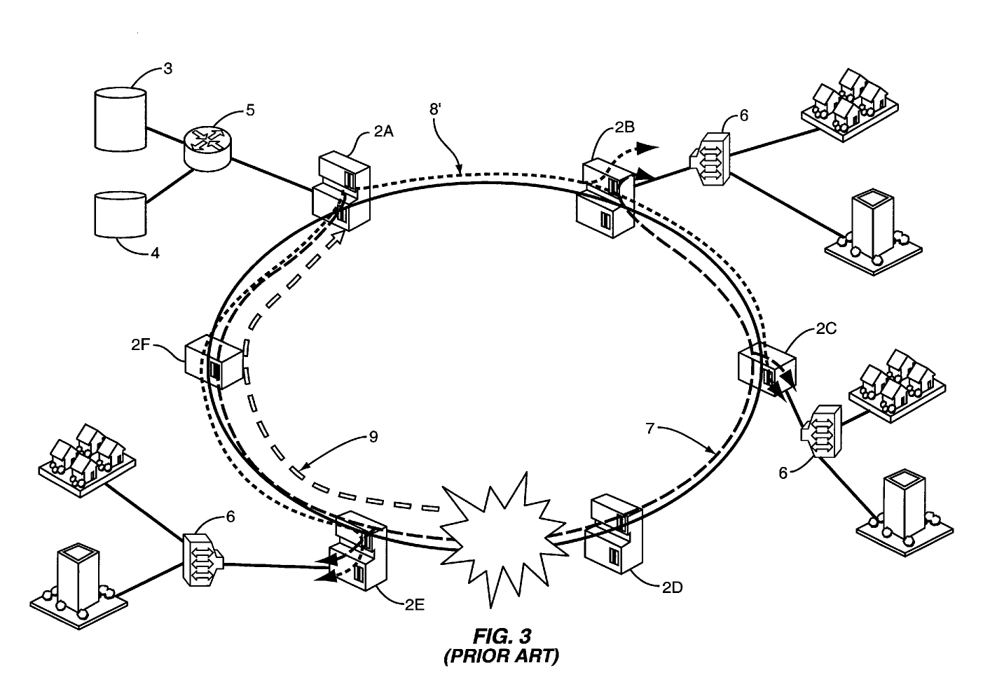

FIG. 4 is a schematic view of a metropolitan network that uses multi-protocol label switching (MPLS) with pre-established LSP one-to-one protection that operates in accordance with the invention.

### DESCRIPTION OF AN EMBODIMENT OF THE INVENTION

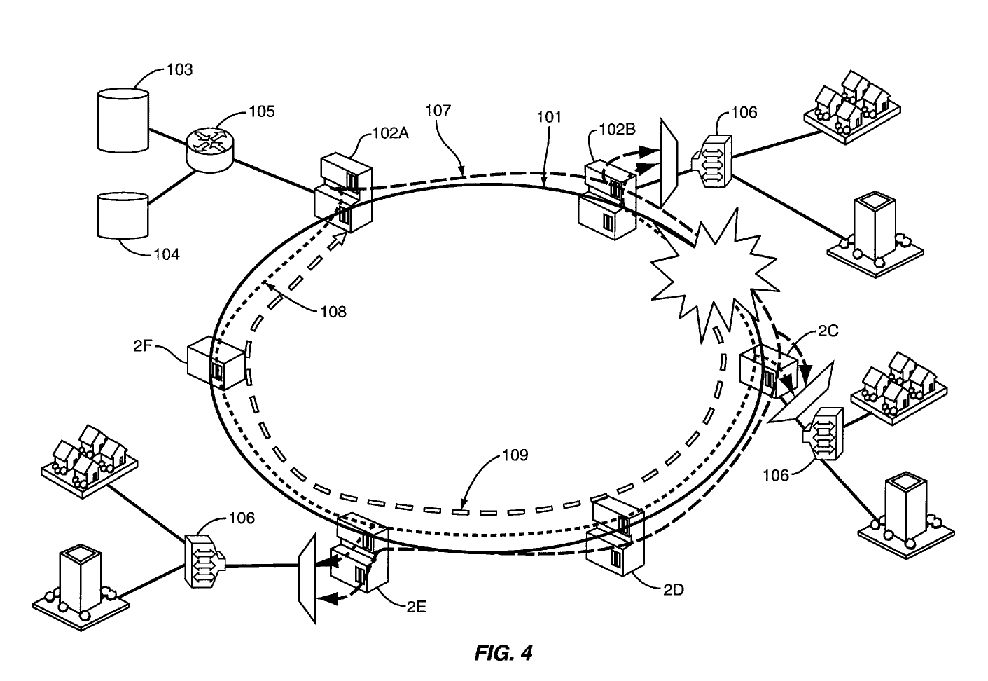

Referring to FIG. 4, a network in accordance with the invention comprises nodes 102A to 102F connected together by a fibre optic communication link 101 having a ring topology. Each egress node 102B to 102F is connected to residential networks via an access node 106. Node 102A is an ingress node connected to a video server 103 and an Internet service provider (ISP) 104 through a router 105.

The network is a MPLS network in which ingress node 102A is arranged to determine which LSP to send data packets on dependent upon the egress node or nodes 102B to 102F the packets need to reach. The ingress node 102A then attaches a label to each data packet, the label being used by downstream nodes 102B to 102F to determine what to do with the packet.

The ingress node 102A and egress nodes 102B to 102F are configured with both the primary LSPs on which communications are sent in normal operation of the network and back-up LSPs on which communications are sent if a fault occurs in the network. In this embodiment of the invention, each primary LSP is provided with a back-up LSP to provide one-to-one protection.

FIG. 4 illustrates with arrow 107 a primary LSP on which packets of a multimedia stream are sent multicast to nodes 102B, 102C and 102E and arrow 108 shows a back-up LSP for that primary LSP.

In the invention, a multicast communication is the sending of data packets from the ingress node to more than one egress node in the network at substantially the same time, wherein each fibre optic connection of the network only carries one copy of the communication, copies of the communication only being made when connections to destination nodes split, for example, in FIG. 4 at the egress nodes. This is in contrast to broadcast or multicast supported by mere packet replication in every point of the network, wherein separate communications are sent to each destination such that any one link of the network may carry more than one copy of the communication, or unicast, wherein a communication is sent to a single destination. Multicast communications are highly desirable for the communications of data for multimedia applications or real-time processing, such as live media events and the like, to the end-user.

The ingress node 102A is programmed to send communications solely on the primary LSP unless the ingress node 102A receives a notification from an egress node 102B to 102F of a fault. Fault detection and notification may be based on prior art techniques, such as physical criteria (for detection), or proprietary or standard Operation, Administration and Maintenance (OAM) messages. In response to receiving a fault notification, for communications to the node or nodes that have reported the fault, the ingress node 102A keeps on sending the communications on the primary LSP 107 but also sends a duplicate of these communications on the back-up LSP 108.

The ingress node 102A is further programmed to stop sending the duplicate communication along the back-up LSP 108 in response to receiving a notification that the fault has been fixed. The ingress node 102A may stop sending the duplicate communication a preset time after receiving the notification. This pre-set time may be configured by the network operator according to specific requirements of the network.

The egress nodes 102B to 102F are programmed to initially (and, preferentially) attempt to receive communications sent on primary LSP 107. However, if the egress node 102B to 102F fails to receive a communication on the primary LSP 107, the egress node 102B to 102F will look to see if a valid duplicate of the communication is being sent on the back-up LSP 108. If the egress node 102B to 102F has been receiving a communication on the back-up LSP 108 then the egress node 102B to 102F will revert to using the primary LSP 107 once a stable communication along the primary LSP 107 becomes available. In order to make sure that stable communication along the primary LSP 107 is available again, each egress node 102B to 102F that switched to the backup LSP during a fault will wait for a pre-determined amount of time after receiving notification that the fault has been fixed before reverting back to using the primary LSP 107. This predetermined time is less (preferably much less) than the pre-set time the ingress node 102A waits before stopping sending the duplicate multicast communication on the backup LSP 108.

As an illustration, a particular example of the networks operation will now be described.

FIG. 4 shows the network in which a fault has occurred on a portion of the communication link preventing communication between nodes 102B and 102C. This fault prevents multicast communication along the primary LSP 107 to nodes 102C and 102E. Such a failure may be caused for example by a mechanical fault in the optical fibre (i.e. fibre/cable cut).

In response to the fault, egress nodes 102C and/or 102E (or also 102B, depending on the fault detection and notification scheme which is in place) send a notification to ingress node 102A notifying the ingress node 102A that a fault occurred on the primary LSP 107. In response to this notification, the ingress node 102A sends the communication on the primary LSP 107 and a duplicate of the communication on the back-up LSP 108. The egress node 102B can still receive the multicast communication on the primary LSP 107 and therefore, continues to do so. However, the egress nodes 102C and 102E can no longer receive the multicast communication on the primary LSP 107 and respond by identifying whether they can receive a duplicate of the multicast communication on the back-up LSP 108. The fault does not prevent communication to nodes 102C and 102E along the back-up LSP 108 and therefore, nodes 102C and 102E switch to receive the valid duplicate multicast communication sent on the back-up LSP 108.

As a duplication of a multicast communication is sent on occurrence of a fault, the bandwidth of the communication link 101 available for other communications sharing a common path with the back-up LSP 108 is reduced. Therefore, the data rate for communications having a lower priority than the multicast communication may be reduced for the duration of the fault. These considerations are part of normal network planning and dimensioning.

Once the fault is fixed, the egress nodes 102C and 102E identify that communications can now be received on the primary LSP 107 and respond by reverting back to receiving communications on the primary LSP 107. The ingress node 102A, responds to receiving notification that the fault has been fixed by stopping sending the duplicate multicast communication on the back-up LSP 108. The ingress node 102A may be programmed to delay stopping the sending of the duplicate multicast communication on the back-up LSP 108 by configurable time. This gives any of the egress nodes 102B to 102F that have switched to receive the duplicate multicast communication on the back-up LSP 108 sufficient time to revert back to receiving the multicast communication on the primary LSP 107 (if required by waiting a minimal amount of time, which may be configured, in order to make sure that the primary LSP is stable).

This embodiment of the invention is advantageous as the fault does not prevent the communication being received by the appropriate egress nodes 102B to 102F, while avoiding the need for significant additional computing to be carried out by the ingress node 102A and signalling to establish a LSP on-demand when the fault occurs. Also, contrary to 1+1 protection schemes, no extra bandwidth is consumed for protection during normal operation. In this way, existing networks can be easily adapted to be in accordance with the invention.

It will be understood that the invention is not limited to the above-described embodiment but modifications and alterations to the embodiment are possible without departing from the scope of the invention as defined in the claims. For example, the network may have a tree, mesh, or fully connected topology.

It will be readily appreciated that technologies may also be used other than MPLS, for example connection oriented Ethernet.

It will be understood that the network may be arranged such that any one of the nodes may act as an ingress node or an egress node dependent on the source of the data/application to be communicated. Accordingly, in one embodiment, the egress node for one or more applications is the ingress node for other applications.

The present invention may, of course, be carried out in other ways than those specifically set forth herein without departing from essential characteristics of the invention. Therefore, the present embodiments are to be considered in all respects as illustrative and not restrictive, and all changes coming within the meaning and equivalency range of the appended claims are intended to be embraced therein.

1. A method of sending a multicast communication across a network comprising an ingress node connected to a plurality of egress nodes via a multicast communication link such that communications can be sent to each egress node from the ingress node along more than one path, the method comprising:
configuring the ingress and egress nodes to communicate over a primary path along the multicast communication link, and configuring a back-up path along the multicast communication link, prior to a network fault occurring; and
if a fault occurs, sending a multicast communication over the primary path, and sending a duplicate of the multicast communication over the back-up path.

2. The method of claim 1 further comprising configuring the ingress and egress nodes to communicate over a plurality of primary paths along the multicast communication link, such that each primary path carries multicast communications from the ingress node to a unique set of egress nodes.

3. The method of claim 2 further comprising, for each of the plurality of primary paths, configuring the ingress and egress nodes to communicate over a back-up path along the multicast communication link.

4. The method of claim 1 wherein the primary path and the back-up path each comprise a multicast label switched path (multicast LSP).

5. The method of claim 1 wherein the primary path and back-up path comprise an Ethernet connection.

6. The method of claim 1 further comprising:
receiving a notification at the ingress node that the network fault no longer exists; and
discontinuing to send the duplicate multicast communication over the back-up path responsive to receiving the notification.

7. The method of claim 6 further comprising delaying the discontinuing to send the duplicate multicast communication over the back-up path for a predetermined delay time after receiving the notification.

8. The method of claim 1 further comprising using multi-protocol label switching (MPLS) to route data packets through the network, and wherein the primary path and the back-up path are specific label switched paths (LSPs) in the network.

9. The method of claim 1 further comprising the egress nodes reverting back to receiving the multicast communications from the ingress node over the primary path a predetermined period of time after receiving notification that the fault has been fixed.

10. An ingress node for a network, the ingress node being connected to a plurality of egress nodes via a multicast communications link such that communications can be sent from the ingress node to each egress node along more than one path, the ingress node comprising:
one or more interfaces to communicatively connect the ingress node to a plurality of egress nodes via a multicast communications link;
a processor configured to:
configure the ingress node to communicate with the egress nodes over a primary path along the multicast communication link, and over a back-up path along the multicast communication link, prior to a network fault occurring; and
if a fault occurs, send a multicast communication over the primary path, and a duplicate of the multicast communication over the back-up path.

11. A data carrier for a network having an ingress node connected to a plurality of egress nodes via a multicast communications link such that communications can be sent to each egress node from the ingress node along more than one path, the ingress and egress nodes being configured to communicate over a primary path along the multicast communication link, and over a back-up path along the multicast communication link, prior to a network fault occurring, the data carrier comprising:
a processor at the ingress node configured to:
receive a notification that a network fault has occurred; and
responsive to receiving the notification, control the ingress node to send a multicast communication to one or more of the egress nodes over the primary path, and to send a duplicate multicast communication to one or more of the egress nodes over the back-up path.

12. An egress node for a network in which the egress node is one of a plurality of egress nodes connected to an ingress node via a multicast communications link such that communications can be sent to the egress node from the ingress node along more than one path, the egress node comprising:
one or more interfaces to communicatively connect the egress node to the ingress node via a multicast communications link; and
a processor configured to:
receive multicast communications from the ingress node over a primary path along the multicast communication link, and over a back-up path along the multicast communication link, prior to a network fault occurring;
detect whether a network fault occurred on the primary path; and
if a fault occurs, identify whether a duplicate of the multicast communication can be received from the ingress node over the back-up path, and switch to the back-up path to receive the duplicate of the multicast communication based on the determination.

13. The egress node according of claim 12 wherein the egress node is configured to:
receive notification that a fault has been fixed; and
revert back to receiving the multicast communication over the primary path a predetermined period of time after receiving the notification.

14. A data carrier for a network having an ingress node connected to a plurality of egress nodes via a multicast communications link such that communications can be sent to each egress node from the ingress node along more than one path, the ingress and egress nodes being configured to communicate over a primary path along the multicast communication link, and over a back-up path along the multicast communication link, prior to a network fault occurring, the data carrier comprising:
a processor at an egress node configured to:
control the egress nodes to receive a multicast communication over the primary path;
if an egress node fails to receive the multicast communication over the primary path, determine whether the egress node can receive a duplicate of the multicast communication over the back-up path; and
switch to receive the duplicate of the multicast communication over the back-up path if the egress node can receive a duplicate of the multicast communication over the back-up path.

15. The data carrier according to claim 14 wherein the processor is further configured to control the egress nodes to revert back to receiving the multicast communication over the primary path a predetermined period of time after receiving notification that the fault has been fixed.

16. A communication network comprising:
an ingress node;
a plurality of egress nodes;
a multicast communication link configured to communicatively connect the ingress node to the plurality of egress nodes such that communications can be sent from the ingress node to each of the egress nodes over more than one path; and
the ingress node configured to:
communicate over a primary path along the multicast communication link, and over a back-up path along the multicast communication link prior to a network fault occurring; and
if a fault occurs, communicate a multicast communication over the primary path, and communicate a duplicate of the multicast communication over the back-up path.

17. The network of claim 16 wherein the multicast communication link comprises a ring topology that communicatively connects the ingress and egress nodes, and that carries communications between the ingress and egress nodes in multiple directions.

18. The network of claim 16 further comprising a plurality of primary paths along the multicast communication link, each having a corresponding back-up path.

19. The network of claim 16 further comprising a plurality of primary paths along the multicast communication link, and wherein the back-up path comprises the sole back-up path to the plurality of primary paths.

20. The network of claim 16 wherein each egress node is configured to switch to receive the duplicate multicast communication over the back-up path if the egress node fails to receive the multicast communication over the primary path.

21. The network of claim 20 wherein the egress nodes are configured to switch to receive the duplicate multicast communications over the back-up path responsive to failing to receive the multicast communication on the primary path.

22. The network of claim 16 wherein the ingress node is configured to:
receive a communication indicating that a fault has occurred in the network; and
send the multicast communication over the primary path, and the duplicate multicast communication over the back-up path, responsive to receiving the notification.

23. The network of claim 16 wherein the network is configured to use a multi-protocol label switching (MPLS) to route data packets through the network, and wherein the primary path and back-up path comprise specific label switched paths (LSPs).

24. The network of claim 16 wherein the multicast communication comprises a data packet addressed to at least one of a multimedia application at a destination device, and a real-time processing at the destination device.

25. The network of claim 16 wherein an egress node for one or more applications comprises the ingress node for other applications.
